(19) United States
(12) Patent Application Publication
(10) Pub. No.: US 2019/0114326 A1
(43) Pub. Date: Apr. 18, 2019

(54) Context-Based Alterations of a Moderated Operating Mode of a Computing Device

(71) Applicant: Motorola Mobility LLC, Chicago, IL (US)

(72) Inventor: Amit Kumar Agrawal, Bangalore (IN)

(73) Assignee: Motorola Mobility LLC, Chicago, IL (US)

(21) Appl. No.: 15/783,411

(22) Filed: Oct. 13, 2017

(51) Int. Cl. G06F 17/30; G06F 15/18

(52) U.S. Cl. CPC G06F 17/3053; G06F 15/18; G06F 17/30699; G06F 17/30029

(57) ABSTRACT

Various implementations provide context-based alterations to a moderated operation mode. To identify context-based alterations, a computing device collects data associated with user interactions with the computing device in order to generate context information. In some implementations, the computing device determines to alter the moderated operating mode based upon an analysis of the generated context information. Alternately or additionally, the computing device alters the moderated operating mode in response to receiving an event of interest. The computing device identifies various characteristics about the event of interest, and uses the identified characteristics to analyze the context information to determine whether to alter the moderated operating mode. In some implementations, the alteration remains until manually modified by a user. Alternately or additionally, some implementations remove the alteration from the moderated operating mode after a predetermined amount of time.

### BACKGROUND

Some computing devices offer various moderated operating modes that the user can enable or disable to change how computing device operates. As one example, a computing device can offer a moderated operating mode that suppresses notifications corresponding to incoming communications or events of interest. In turn, the user can enable this moderated operating mode during times they do not want to be disrupted, such as during a business meeting, while driving, during a family meal, and so forth. As another example, a computing device can offer a moderated operating mode that corresponds to an audio control operating mode that plays audible output notifications of incoming communications and events of interest, and processes incoming audio to discern input commands from the user. An audio control operating mode can be useful to the user in scenarios where they are unable to physically interact with the computing device, such as when their hands are occupied with another task, away from the computing device but within audible distance, etc. In each of these examples, a moderated operating mode applies a user preference (e.g., silenced communications, audible inputs/outputs) to how the computing device responds to communications and events of interest. Unfortunately, depending upon its current state (e.g., enabled or disabled) these moderated operating modes can also erroneously suppress and/or fail to audibly announce notifications related to events that the user has an elevated interest in relative to other events, thus causing further delay in the user responding to the events.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an overview of a representative environment that includes an example of context-based alterations to a moderated operation mode in accordance with one or more implementations;

FIG. 2 illustrates a more detailed example of context-based alterations to a moderated operation mode in accordance with one or more implementations;

FIG. 3 illustrates an example of collecting data for context information in accordance with one or more implementations;

FIG. 4 illustrates an example of an event of interest occurring in accordance with one or more implementations;

FIGS. 5a-5b illustrate an example of selectively altering a moderator mode based upon context information in accordance with one or more implementations;

FIG. 6 illustrates an example of selectively altering a moderator mode based upon context information in accordance with one or more implementations;

FIG. 7 illustrates a flow diagram that alters a moderator mode based on context information in accordance with one or more implementations; and

FIG. 8 is an illustration of an example device in accordance with one or more implementations.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Various implementations provide context-based alterations to a moderated operation mode. To identify context-based alterations, a computing device collects data associated with user interactions with the computing device in order to generate context information. In some implementations, the computing device determines to alter the moderated operating mode based upon an analysis of the generated context information. Alternately or additionally, the computing device alters the moderated operating mode in response to receiving an event of interest. The computing device identifies various characteristics about the event of interest, and uses the identified characteristics to analyze the context information to determine whether to alter the moderated operating mode. In some implementations, the alteration remains until manually modified by a user. Alternately or additionally, some implementations remove the alteration from the moderated operating mode after a predetermined amount of time.

Consider now an example environment in which various aspects as described herein can be employed.

Example Environment

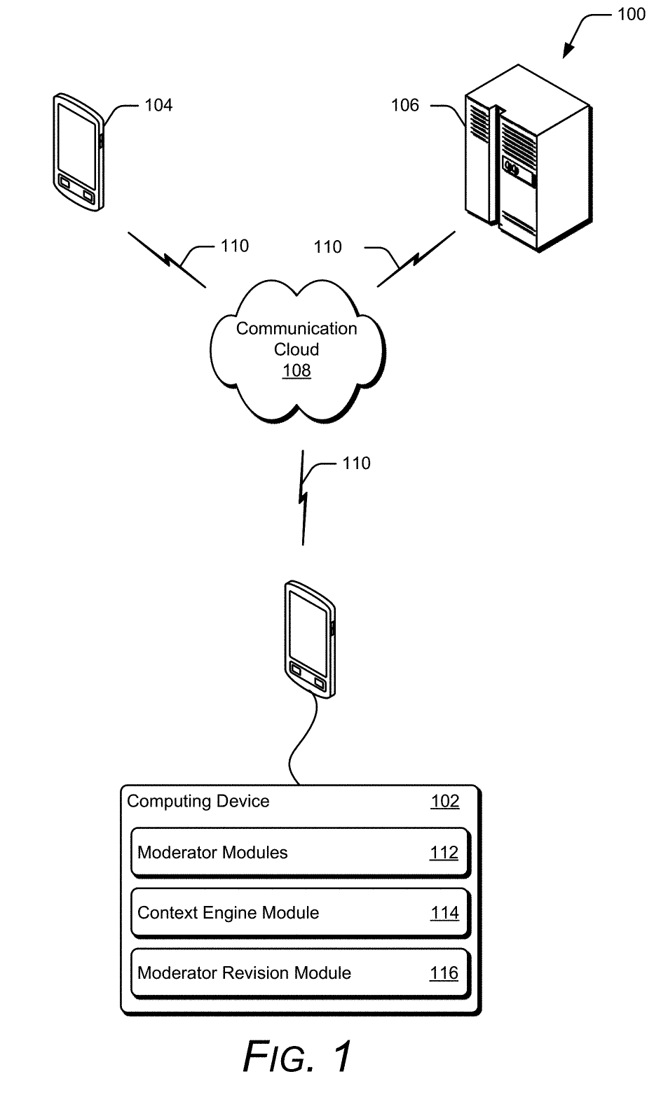

FIG. 1 illustrates an example environment 100 in accordance with one or more implementations. Environment 100 includes computing device 102 (in the form of a mobile phone) that is capable of exchanging communications with other devices. To illustrate this capability, environment 100 includes mobile phone 104 and server 106 that communicate with computing device 102 over communication cloud 108. Using communication cloud 108, computing device 102 can exchange text communications, voice communications, e-mails, and/or video communications with mobile phone 104. Alternately or additionally, computing device 102 can access, or exchange data with, server 106 using communication cloud 108, such as by accessing a web site hosted by server 106, accessing an e-mail client that connects with server 106, accessing a shopping application supported by server 106, and so forth.

Communication cloud 108 generally represents any suitable type of communication network that facilitates a bi-directional link between various computing devices. Communication cloud 108 can include multiple interconnected communication networks that comprise a plurality of interconnected elements, such as a wireless local area network (WLAN) with Ethernet access, a wireless telecommunication network interconnected with the Internet, a wireless (Wi-Fi) access point connected to the Internet, and so forth. In this example, communication cloud 108 connects computing device 102 with mobile phone 104 and server 106 via communication links 110. These communication links generally represent communication paths can be used to exchange any suitable type of data and/or information. In some implementations, communication links 110 represent a communication link that is local to computing device 102, such as a Bluetooth™ wireless link, an infrared wireless communication link, a direct cable connection between devices, and so forth. Alternately or additionally, communication links 110 represent links to remote devices, examples of which are provided herein.

Computing device 102 includes moderator modules 112, context engine module 114, and moderator revision module 116. Moderator modules 112 represent functionality that moderates the operation of computing device 102. To illustrate, consider an example where computing device 102 operates in a default mode that plays an audible noise to notify the user of an incoming voice call, but does not process audible input to identify input commands. Some implementations of computing device 102 include a notification suppression moderator module that regulates how computing device notifies a user of incoming communications, such as a Do-Not-Disturb operation mode that suppresses audible and/or visual notifications related to incoming communications, events of interests, etc. Accordingly, by enabling the notification suppression moderator module, a user can alter the default operation of computing device 102 from playing audible notifications to an operating mode that suppresses the audible notifications. As another example, computing device 102 can include an audio control moderator module that regulates how computing device 102 processes input/output. When enabled, the audio control moderator module changes the default operating computing device 102 from not processing audible inputs to an operating mode that processes input audio to identify commands. Alternately or additionally, the audio control moderator module can, when enabled, generate audible text-to-speech output notifications corresponding to incoming communications and/or events of interest, such as an incoming voice call, an incoming e-mail, a calendar appointment alert, a weather change, a social media notification, and so forth. Computing device 102 can include any number of moderator modules 112 that can be in any combination of states (e.g., all enabled, all disabled, some enabled, some disabled, etc.).

Context engine module 114 tracks raw data about a user and/or generates context information about the user by analyzing the raw data. Raw data can include any singular type of data, such as a count of button clicks on a particular application, a timestamp, relationship information for a contact, and so forth. Context information represents an analysis and/or interpretation of that raw data, such as an average value generated from the raw data, user application preferences, user communication mode preferences (e.g., text, e-mail, voice, etc.), most frequently visited websites, user preferred contacts, pending purchase transactions, the last time the user communicated with a particular contact, and so forth. Together and/or independent from one another, the raw data and context information describe a context about the user and/or the user's interactions with computing device 102. In one or more implementations, the context information includes context information associated with communication events, such as a number of voice/video calls, number of text messages, number of successful incoming and/or outgoing communication attempts, number of unsuccessful incoming and/or outgoing communication attempts, time duration between the last communication attempt with a contact, and so forth. Accordingly, context engine module 114 can track or store information that identifies items and/or actions of interest to the user which can be subsequently applied to various types of communication events. Any suitable type of algorithm can be used to generate the contextual data, such as statistical operations, Decision Trees, Advanced Data Mining Techniques, Linear Regression, Apriori Learning, K-means Learning, and so forth.

Moderator revision module 116 analyzes the context information generated by context engine module 114, and determines whether to revise and/or apply an alteration to one or more moderator modules 112 based upon the analysis. For instance, moderator revision module 116 can subscribe to and/or receive notification of various events of interest, such as an incoming voice call, and extract various characteristics about the event of interest. In the example of the incoming voice call, moderator revision module 116 can identify a characteristic corresponding to a sender or originator of incoming voice call, and then analyze the context information based upon the identified characteristic to determine whether to revise a current operating mode of a moderator module. In other words, moderator revision module 116 can determine whether to make an exception or modification to the operating state of a moderator module for the particular event of interest and/or originator of the event of interest. Alternately or additionally to running an analysis based upon an incoming communication event, the context engine module 114 can invoke the moderator revision module to run an analysis after generating or obtaining new context information, such as after an unsuccessful communication attempt with a particular contact. The determination on whether to revise the current operating mode can be based upon any suitable type of metric or context as further described herein.

When moderator revision module 116 decides to modify a moderator module, moderator revision module 116 can alter a state of the moderator module, alter a state of a contact or address to affect how the moderator module processes events corresponding to the contact or address, or any combination thereof. As one example, the moderator revision module can change the state of a particular contact to revise or alter how a corresponding moderator module processes various events of interest associated with the particular contact, such as an incoming communication from the particular contact. The revision to a moderator module can be temporary revision that is enabled for a predetermined duration of time and/or can be a more enduring revision that changes when a user manually modifies it.

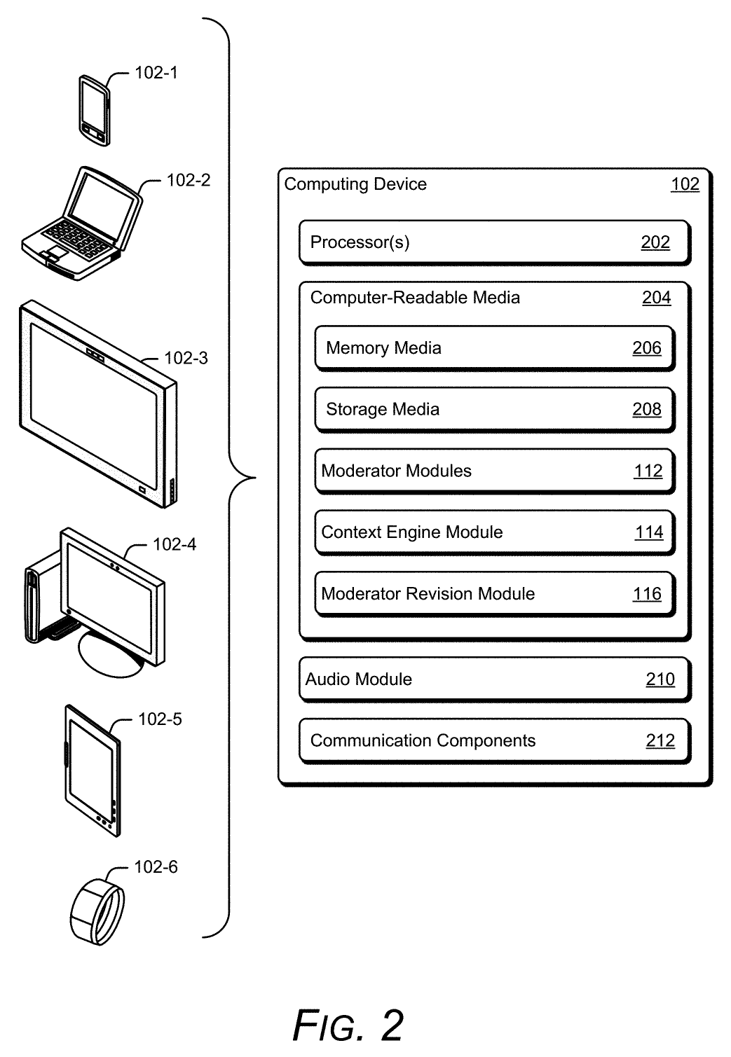

FIG. 2 illustrates an expanded view of computing device 102 of FIG. 1 with various non-limiting example devices including: smartphone 102-1, laptop 102-2, television 102-3, desktop 102-4, tablet 102-5, and smart watch 102-6. Accordingly, computing device 102 represents any suitable device that incorporates altering a moderator module based upon context information as further described herein. Computing device 102 includes processor(s) 202 and computer-readable media 204, which includes memory media 206 and storage media 208. Applications and/or an operating system (not shown) embodied as computer-readable instructions on computer-readable media 204 are executable by processor(s) 202 to provide some, or all, of the functionalities described herein. For example, various embodiments can access an operating system module that provides high-level access to underlying hardware functionality by obscuring implementation details from a calling program, such as protocol messaging, register configuration, memory access, and so forth.

Computer-readable media 204 includes moderator modules 112, context engine module 114, and moderator revision module 116 of FIG. 1. While moderator modules 112, context engine module 114, and moderator revision module 116 are illustrated here as residing on computer-readable media 204, they can alternately or additionally be implemented using hardware, firmware, software, or any combination thereof.

Computing device 102 includes audio module 210 and communication components 212. Audio module 210 represents functionality that can audibly project notifications, such as a speaker and/or an earphone jack that connects to external speakers. Communication components 212 represent functionality that enables computing device 102 to physically transmit data to, and receive data from, external devices, such as an input/output port or a transceiver chain. Some portions of communication components 212 perform signal and/or protocol processing to implement data transfer via communication links 110 of FIG. 1. While audio module 210 and communication components 212 are illustrated here as single components, each can be implemented as varying combinations of hardware, firmware, and/or software. For instance, in some embodiments, audio module 210 and/or communication components 212 comprise hardware that includes embedded firmware. Alternately or additionally, hardware components of audio module 210 and/or communication components 212 can couple to a software driver that an application interfaces with in order to access functionality provided by the hardware.

Having described an example operating environment in which various aspects of context-based alterations to a moderated operating mode can be utilized, consider now determining when to revise an operating mode based on context information in accordance with one or more implementations.

Revising an Operating Mode Based on Context Information

Moderated operating modes provide users with a way to customize or change how a computing device processes events of interest relative to a default mode of processing the events of interest. If a user wishes to suppress notifications from the computing device, some implementations include a notification suppression moderator module, such as a Do-Not-Disturb module, that, once enabled, silences audible and/or visual notifications to the user. In other words, the notification suppression moderator module represents a notification suppression operating mode. As another example, some implementations include an audio control operating mode that, when enabled, processes audio input commands, and/or generates audible output notification of various events of interest. For instance, the audio control operating mode can process audio to identify an audible input command that indicates to read out the incoming email, and subsequently generate an audible output notification that converts the content of the incoming email to audio using the text-to-speech algorithms.

Some computing devices also allow a user to manually classify particular contacts as exceptions to a moderated operating mode so that the corresponding functionality of the moderated operating mode does, or does not, apply to the exception. To illustrate, consider again an enabled Do-Not-Disturb mode that suppresses audible and/or visual notifications to the user. By manually classifying a particular contact as an exception or priority contact, the user can enable the Do-Not-Disturb mode to suppress notifications of various events of interest, but still receive notifications of incoming communications from the contact classified as a priority contact. In other words, the computing device plays audible and/or displays visual notifications for incoming communications or events of interest associated with the particular contact, even though Do-Not-Disturb is enabled. This allows the user to suppress most notifications, but circumvent the suppression for events associated with particular contacts. While manual classifying contacts as exceptions or priority contacts allows the user to bypass moderated operating modes, it can be cumbersome to apply this classification to temporary communications and/or contacts the user does not communicate with frequently. For example, the user may readily classify a parent, friend, or sibling they communicate with frequently as an exception since they have a known communication pattern with these contacts, and likely have the contacts stored in a corresponding address book. However, the user may be less inclined to classify a temporary address or telephone number, such as a car garage or acquaintance not stored in an address book, since the user communicates with these address less frequently than stored contacts. Thus, the manual classification process does not account for contacts that are not stored in the address book and/or contacts that have a temporary importance to the user over a predetermined timeframe.

Various implementations provide context-based alterations to a moderated operation mode. By altering a moderated operating mode based on context information, a computing device can determine when a particular incoming communication or event of interest is important or relevant to the user without manual classification information from the user. For example, context-based alterations to a moderated operating mode can identify exceptions to the moderated operating mode based upon context and, in turn, automatically alter how the computing device responds to the exceptions. This can help the user detect when events of interest occur, rather than missing them.

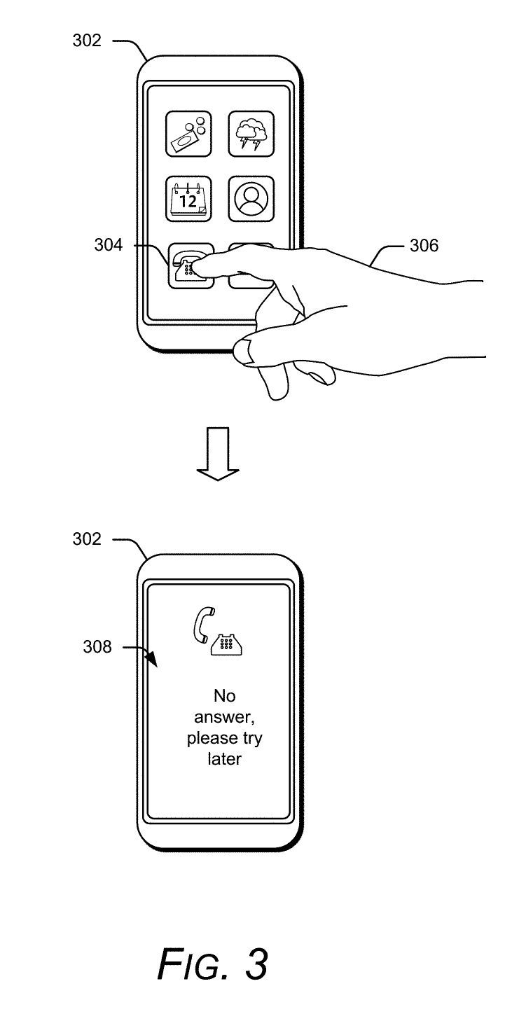

To demonstrate, consider FIG. 3 that illustrates mobile phone 302. In some implementations, mobile phone 302 is representative of computing device 102 of FIG. 1. In this example, assume that mobile phone 302 is operating with an audio control operating mode disabled. In other words, mobile phone 302 includes a moderator module that can generate text-to-speech audio output notifications and/or and receive audio input commands. Alternately or additionally, mobile phone 302 includes a moderator module that, when enabled, suppresses audible and/or visual notifications corresponding to events of interest.

Mobile phone 302 also includes various features that the user can access, as illustrated in the upper portion of FIG. 3. For example, mobile phone 302 includes a voice communication application that the user can invoke via telephone icon 304. When invoked, the voice communication application allows a user to make voice calls to various telephone numbers. This can include Voice over Internet Protocol (VoIP)-based telephone calls, cellular-based telephone calls, public switched telephone network (PSTN)-based telephone calls, and so forth. At some point in time, user 306 initiates a call to a particular telephone number by selecting telephone icon 304. The telephone number can have any type of association with the user, such as a telephone number associated with a contact stored in an address book, or have a lack of association with the user, such as no association with a stored contact in the address book. Various implementations track or gather data about this user interaction to generate context information. For instance, context engine module 114 of FIG. 1 (not illustrated here) can gather time stamp information of when user 306 interacts with telephone icon 304, contact information of the callee (e.g., telephone number, email address, name, etc.), duration of the communication, type of communication invoked, and so forth. In some implementations, the context engine module gathers data that identifies whether the communication attempt was successful or unsuccessful. For instance, in the lower portion of FIG. 3, mobile phone 302 displays a user interface 308 corresponding to the voice communication application that indicates the call was unsuccessful. The context engine module can interface with the voice communication to gather information that indicates the user initiated a voice communication attempt, a callee of the communication attempt, a time corresponding to the communication attempt, and/or that the communication attempt was unsuccessful. This can be achieved in any suitable manner, where the context engine module queries for the information and/or the information is automatically pushed to the context engine module using various features provided by an operating system and/or the voice communication application. While described in the context of a voice communication exchange, the context engine module can monitor and gather data corresponding to other forms of communication as well. For example, after the unsuccessful voice communication attempt, the user may next attempt to send a text message to the same contact using a different and/or same telephone number. In turn, the context engine module can gather data that identifies whether the text message goes unread, whether user 306 receives of reply or not via text messaging, and so forth. In these scenarios, the context engine module can correlate the different forms of communication attempts to the same contact, and determine whether they both are unsuccessful, whether one is unsuccessful, and so forth, thus providing context information about various communication interactions.

In some implementations, the context engine module of mobile phone 302 gathers and/or generates data that indicates a predetermined number of unsuccessful communication attempts have been made by the user to a same contact address. This can include the context engine module correlating several different types of contact addresses and/or communication types to a same destination. For example, a particular contact (whether stored in an address book or not), can have a landline number, a cellular phone number, a work email address, a personal email address, a social media account, and so forth. Some implementations of the context engine module associate these different contact addresses to a same destination and/or contact such that the context engine module can identify when multiple communication attempts have been made to a same destination. In some implementations, when the number of unsuccessful communication attempts meets or exceeds a predetermined threshold value, mobile phone 302 determines to alter a moderator mode as further described herein. For example, a moderator revision module can analyze the context information after an event of interest, and make a determination of whether to revise a moderator module or not.

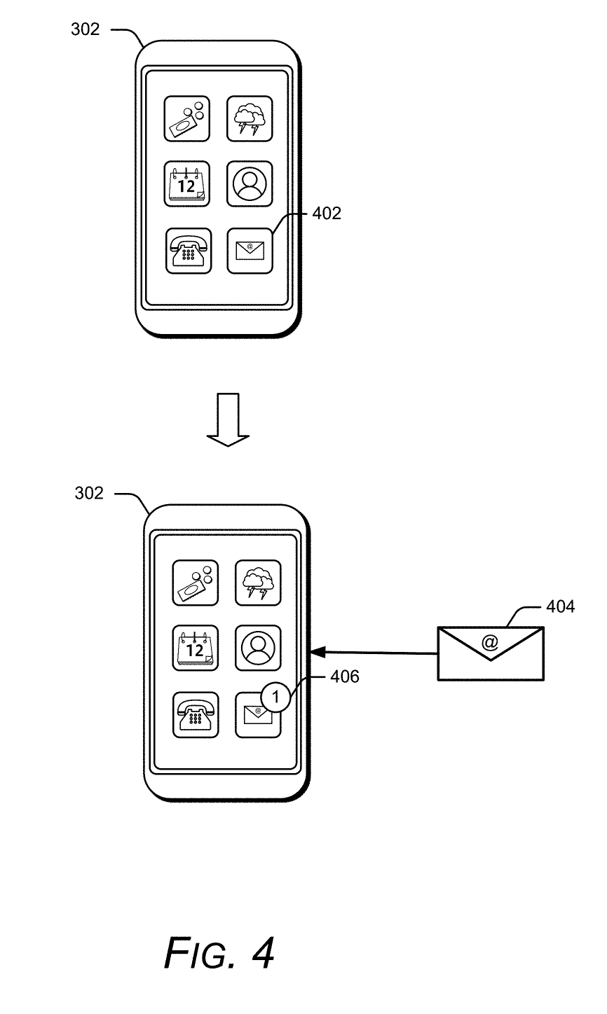

As one example of an event of interest, consider now FIG. 4 that includes mobile phone 302 from FIG. 3. In some scenarios, FIG. 4 can be considered a continuation of the example described with respect to FIG. 3. Here, mobile phone 302 includes an e-mail client that is accessible to the user via e-mail icon 402 that is illustrated in the upper portion of FIG. 4. When invoked, the e-mail client provides the user with access to electronic communications that are supported by a remote server. Thus, the user can compose e-mails to send out, as well as read the content of incoming e-mails, by invoking the e-mail client. Similar to that described with respect to the voice communication application, the user can invoke the e-mail client by interacting with e-mail icon 402.

At some point later in time, as illustrated in the lower portion of FIG. 4, the user receives an incoming e-mail 404 that is considered an event of interest. Assume now that the incoming e-mail is from the same contact that the user attempted to notify using the voice communication application as discussed with respect to FIG. 3, and that the user has not designated the contact as a priority contact that can circumvent various moderator modes as further described herein. To notify the user of the incoming email, mobile phone 302 visually displays a notification icon 406 on top of e-mail icon 402. However, if the user is not within visual range of mobile phone 302, the notification may go unnoticed, subsequently causing a delay in when the communication cycle between the user and the contact completes successfully. If the audio control operating mode is disabled and/or the contact is not classified as a priority contact, mobile phone 302 does not generate an output audible notification corresponding to the incoming e-mail. Thus, assuming the user does not see the visual notification, the communication cycle becomes prolonged and potentially creates more frustration to the user.

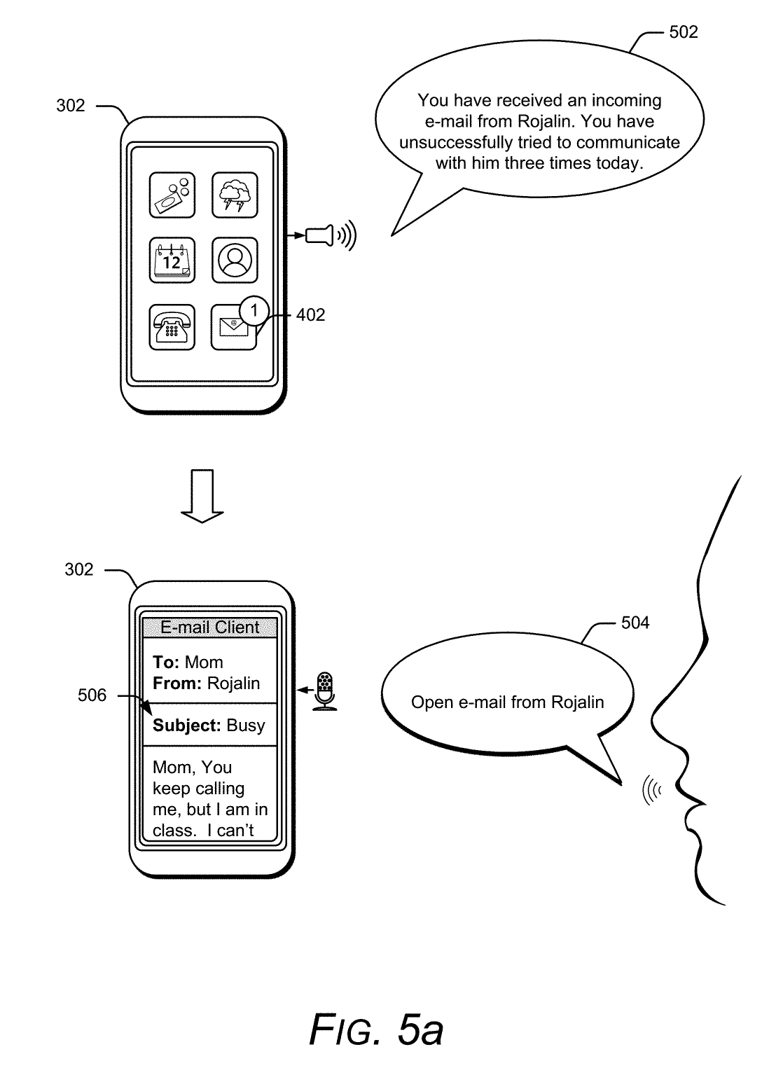

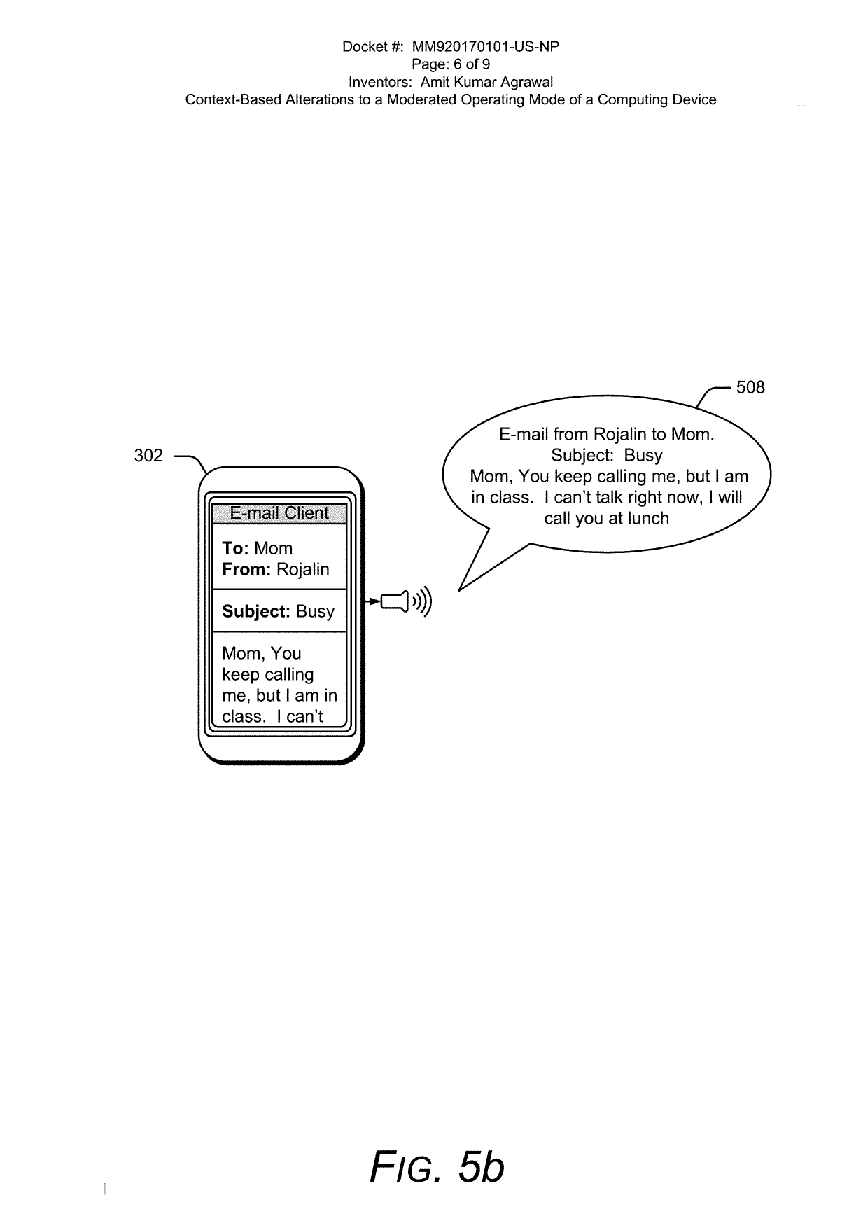

Various implementations use context information to determine whether to alter a moderator mode as further described herein. To demonstrate, now consider FIG. 5a and FIG. 5b. In some scenarios, FIGS. 5a and 5b are continuations of the examples described with respect to FIG. 3 and/or FIG. 4. In the upper portion of FIG. 5a, mobile phone 302 identifies that the incoming e-mail 404 has originated from a contact with which the user has had multiple unsuccessful communication attempts. For instance, mobile phone 302 can use moderator revision module 116 of FIG. 1 (not illustrated here) to first identify various characteristics about the incoming e-mail 404. Any suitable type and combination of characteristics can be identified, such as identifying the sender, identifying the content of the communication includes predefined phrases (a name, an address, a store name, a garage name, etc.), time-based characteristics, date-based characteristics, location-based characteristics, application-based characteristics, contact-based characteristics, domain- and/or address-based characteristics, last successful communication, number of unsuccessful communications, etc.

Upon identifying the various characteristics, the moderator revision module analyzes the context information generated by the context engine module to determine that there have been multiple unsuccessful communication attempts with the originator of e-mail 404. For instance, the moderator revision module can compare the number of unsuccessful attempts to a predetermined threshold number. If the number of unsuccessful attempts matches or exceeds the predetermined threshold number, the moderator revision module then determines to revise or alter a moderator mode as further described herein. Here, mobile phone 302, by way of the moderator revision module, determines to enable the audio control operating mode for the particular incoming communication and/or the particular sender of the incoming communication (e.g., incoming e-mail 404), such as by automatically and without user intervention classifying the originator/sender of e-mail 404 as a priority contact. Alternately or additionally, mobile phone 302 can enable the audio control operating mode for all communications and/or events of interests. After enabling the audio control mode, mobile phone 302 generates an audible notification 502 that includes two portions: a first portion that audibly indicates an event of interest has happened: “You have received an incoming e-mail from Rojalin”, and a second portion that provides context information to the user: “You have unsuccessfully tried to communicate with him three times today”. However, other combinations of information can be included in the audible notification without departing from the scope of the claimed subject matter.

Since mobile phone 302 has revised the audio control operating mode to an enabled state, some implementations process audio input to identify input commands. Accordingly, in the lower portion of FIG. 5a, the user audibly states an audible input command 504 to mobile phone 302: “Open e-mail from Rojalin”. In turn, after receiving and identifying the input command, mobile phone 302 invokes the e-mail client without the user physically interacting with e-mail icon 402, and displays a user interface 506 that includes the content of the incoming e-mail. The audible input command can be received and processed in any suitable manner, such as through the use of a microphone electronically coupled to an analog-to-digital converter (ADC) to generate digital samples of the corresponding audio, and various digital signal processing (DSP) algorithms that process the digital samples to identify an input command. In response to the audible input command, mobile phone 302 outputs audible content 508 that has converted text included in the incoming communication into audible speech.

In combination, FIGS. 3-5 illustrate an example in which mobile phone 302 determines to alter its audio control moderator module based upon an event of interest: incoming e-mail 404. The receipt of e-mail 404 at mobile phone 302 triggers an analysis process based on characteristics of the incoming email. In turn, the analysis determines to make an alteration to a moderator mode. However, the analysis process can be triggered by other events of interest as well. For example, consider again FIG. 3 in which the user attempts to communicate unsuccessfully with a particular telephone number. Upon termination of the unsuccessful communication event, some implementations analyze the context information to make a determination on whether to alter a moderator mode, rather than waiting for an incoming communication to trigger the analysis. If the analysis determines that the unsuccessful communication events meet or exceed the predefined threshold, the moderator revision module can automatically classify the corresponding address and/or contact information as a priority contact so that the moderator module processes future incoming communications from the contact in an altered manner as further described herein. Thus, mobile phone 302 can trigger the analysis and/or alteration process based on any suitable event, whether it is an external event and/or internal event (e.g., an incoming communication, a device moving into a particular location, identifying a threshold has been met, during a scheduled time-period, a calendar appointment, etc.).

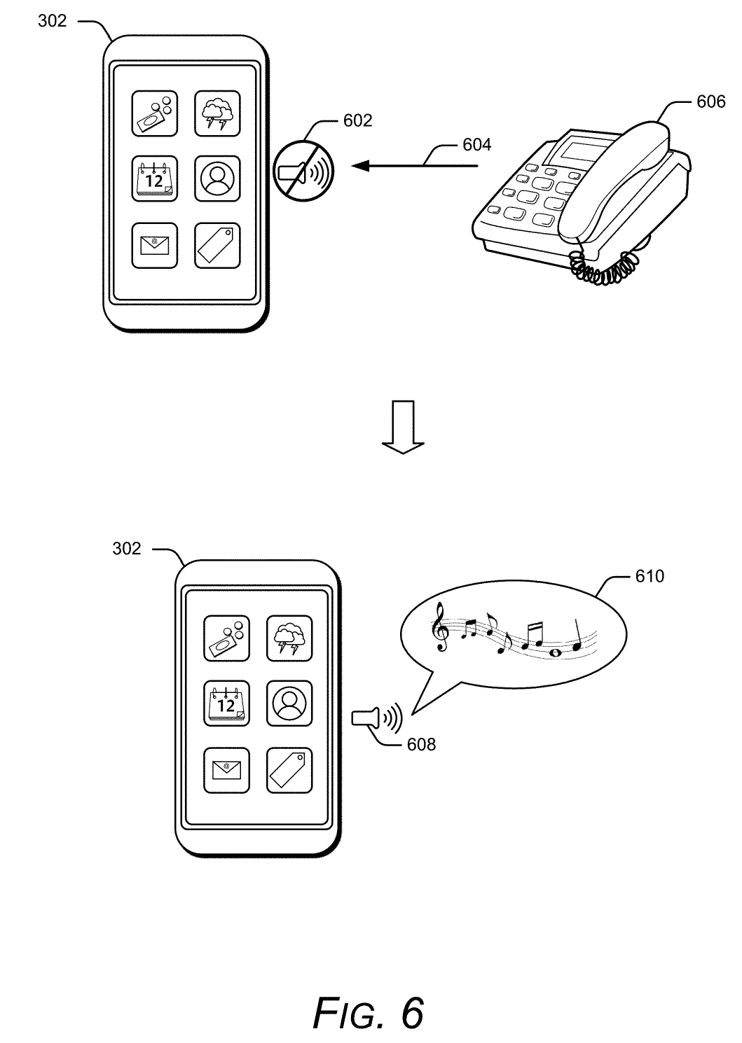

With respect to the FIGS. 3, 4, and 5, mobile phone 302 uses context information to determine whether to alter a corresponding audio control operating mode to an enabled state in an attempt to help alert the user that event of interest that has occurred. However, a computing device can enable or disable other types of moderator modes as well. To illustrate, now consider FIG. 6 that includes mobile phone 302 of FIG. 3. In some scenarios, FIG. 6 is a continuation of the examples described with respect to FIG. 3, FIG. 4, and/or FIG. 5. In FIG. 6, the user has enabled a Do-Not-Disturb mode that suppresses audible notifications to the user, indicated here by suppressed speaker 602. Alternately or additionally, the Do-Not-Disturb mode can suppress outputting visual notifications, and or processing audible input commands.

In the upper portion of FIG. 6, mobile phone 302 receives an incoming audio call 604 from landline phone 606, where the user has not stored the telephone number corresponding to landline phone 606 in a corresponding address book of mobile phone 302 and/or has not designated the telephone number as a priority contact. To illustrate, consider a scenario in which the user of mobile phone 302 has attempted to establish an audio call with a car garage several times unsuccessfully. For the user, contacting the car garage is atypical or occurs less frequently relative to other telephone numbers stored in an address book of mobile phone 302. Subsequently, the user has not designated the car garage as a priority contact, nor has the user stored the corresponding telephone number in the address book.

As further described herein, mobile phone 302 tracks these unsuccessful communication attempts and generates context information that can be used to correlate the unsuccessful communication attempts with the telephone number associated with the car garage. In turn, mobile phone 302 determines to automatically classify the telephone number as a priority contact. This can occur at any suitable point in time, such as at the termination of an unsuccessful voice communication to the telephone number and/or when mobile phone 302 receives an incoming communication from the telephone number. For example, referring to the scenario in which mobile phone 302 identifies the termination of an unsuccessful voice call to the telephone number, some implementations identify various characteristics about the unsuccessful voice call, and base an analysis of the context information on these characteristics. Alternately or additionally, when mobile phone 302 receives incoming audio call 604, various implementations identify characteristics about the incoming audio call (e.g., the corresponding telephone number), and analyze the context information to make a determination on whether the incoming communication has more importance to the user relative to other events of interest.

Whether performed at the termination of an unsuccessful communication attempt or when an incoming call is received, mobile phone 302 identifies that the communication is associated with the car garage, and that mobile phone 302 has had several unsuccessful communication attempts with the telephone number. Based on this analysis, mobile phone 302 determines to disable the Do-Not-Disturb mode for the particular incoming communication, such as by automatically classifying the telephone number corresponding to the incoming audio call as a priority contact for a temporary and/or predetermined amount of time. However, any other type of contact information that is used to establish a communication exchange with a destination can alternately or additionally be classified as a priority contact without departing from the scope of the claimed subject matter. Accordingly, mobile phone 302 plays out audio notification 608 via unsuppressed speaker 610 to notify the user of the incoming audio call because of the context-based alteration to the Do-Not-Disturb mode. Thus, even though Do-Not-Disturb has been enabled by the user, mobile phone 302 uses context information to determine that an incoming communication has an elevated importance to the user relative to other events of interest, and modifies a moderator mode in order to better alter the user. While FIG. 6 illustrates mobile phone 302 automatically classifying the telephone number as a priority contact in response to the incoming audio call, it is to be appreciated that other implementations can automatically classify the telephone number as a priority contact at different times and/or in response to different events (e.g., at the termination of an unsuccessful communication attempt).

The alteration to a moderator mode can be a temporary alteration or a more enduring alteration. For example, some implementations can make an alteration for a predetermined amount of time, and then remove the alteration after the predetermined amount of time expires. This can be achieved in any suitable manner, such as through the use of a timer that is set for the predetermined amount of time. As another example, a computing device can use an event to bound the predetermined amount of time. Consider scenarios in which the alteration occurs based upon context information that indicates a predetermined number of unsuccessful communication attempts. Some implementations maintain the alteration to the moderator mode until a successful communication exchange has occurred, at which point the alteration is removed. Thus, a computing device can maintain an alteration for a time duration bound by a predetermined time period or event, at which point the alteration is removed. In other implementations, the alteration is more enduring and persists until the user manually removes the alteration and/or manually changes an operating state of the moderator mode.

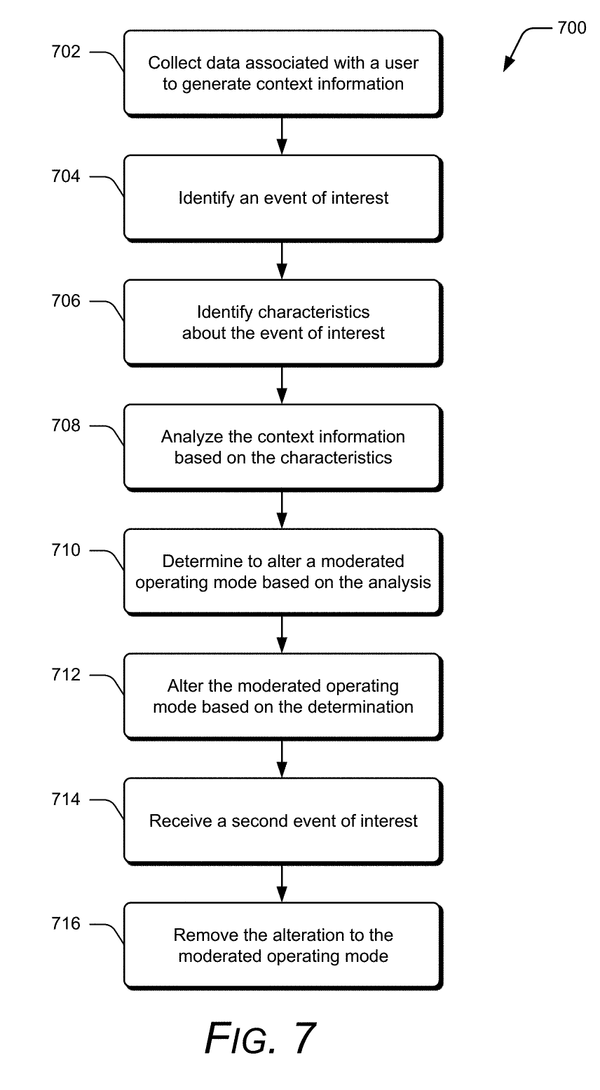

Now consider FIG. 7 that illustrates a method 700 that uses context-information to modify a moderator mode in accordance with one or more implementations. The method can be performed by any suitable combination of hardware, software, and/or firmware. In at least some embodiments, aspects of the method can be implemented by one or more suitably configured hardware components and/or software modules, such as moderator modules 112, context engine module 114, and/or moderator revision module 116 of FIG. 1. While the method described in FIG. 7 illustrates these steps in a particular order, it is to be appreciated that any specific order or hierarchy of the steps described here is used to illustrate an example of a sample approach. Other approaches may be used that rearrange the ordering of these steps. Thus, the order steps described here may be rearranged, and the illustrated ordering of these steps is not intended to be limiting.

At 702, a computing device collects data associated with a user to generate contextual and/or historical information about the user. For example, the computing device can collect data on frequently used applications relative to other applications, frequently used websites relative to other websites, uncompleted communication attempts (by the user and/or to the user), contact relationship information, preferred communication modes, call log information, the computing device is moving to a particular location, etc. In some implementations, the data collection process collects raw data, such as timestamp data points, usage counts, time-to-response data points, and so forth. Alternately or additionally, the data collection process can include generating context information from the raw data, such as analyzing each time-to-response data point to identify which contact the user responds to the quickest, which contact the user ignores, etc. Some implementations generate context information that describes contacts and/or addresses that the user has had unsuccessful communications with, how many unsuccessful communication attempts have occurred, which types of communications have occurred, and so forth.

At 704, the computing device identifies an event of interest. In some implementations, the event of interest pertains to an incoming communication event, such as a voice call, a text message, a video call, an e-mail message, so forth. Alternately or additionally, the event of interest pertains to an outgoing communication event, such as an outgoing voice call, outgoing text message, outgoing e-mail, outgoing video call, and so forth. In some implementations, the event of interest can be internally generated by the computing device (e.g., an appointment reminder).

At 706, the computing device identifies characteristics about the event of interest. For example, some implementations identify an outgoing address corresponding to an outgoing communication event and/or and originating address corresponding to an incoming event.

Upon identifying characteristics, the computing device analyzes the context information based on the characteristics at 708. The analysis can identify any suitable type of context information associated with the event of interest. In some implementations, the analysis identifies whether there are multiple unsuccessful communication attempts with a corresponding contact, examples of which are further provided herein. This can include identifying unsuccessful outgoing communication attempts, unsuccessful incoming communication attempts, a time period between communication attempts, and so forth. The analysis can alternately or additionally identify a current state associated with each moderator module within the computing device, such as determining whether an audio control moderator module is in an enabled or disabled state, whether a notification moderator module is in an enabled or disabled state, and so forth.

At 710, the computing device determines to alter a moderated operating mode based on the analysis. For example, consider a scenario in which the moderated operating mode suppresses audible and/or visual notifications for all contacts included within an address book of the computing device, except for contacts designated as priority contacts. In some implementations, the computing device determines to alter the moderated operating mode for a contact that is not designated as a priority contact and/or that is missing from the address book based upon the context information, such as a number of unsuccessful communications exceeding a predetermined threshold for the undesignated and/or missing contact. Accordingly, at 712, the computing device alters the moderated operating mode based on the determination to alter how the computing device moderates communications associated with that contact. For instance, the computing device can temporarily designate the missing and/or undesignated contact as a priority contact. In turn, the moderated operating mode changes how it processes and/or response to the newly designated priority contact relative to when the contact was undesignated.

After altering the moderated operating mode, the computing device receives a second event of interest at 714. The second event of interest can occur at any arbitrary point in time after the moderated operating mode has been altered. In some implementations, the second event of interest corresponds to an external event, such as an incoming communication from the newly designated priority contact, or user input and/or the user answering (via the computing device) an incoming voice communication to establish a successful communication exchange. Alternately or additionally, the second event of interest corresponds to an internally generated event, such as a timer expiring, an appointment notification, and so forth. Responsive to receiving the second event of interest, the computing device removes the alteration to the moderated operating mode at 716. For example, in the scenario where the computing device newly designates a contact as a priority based upon context information, the computing device would remove the classification of the contact as a priority contact.

By altering how a moderated operating mode processes events of interest based on context information, a computing device provides the user with improved communication accessibility. Further, the computing device can provide the improved communication accessibility without any extra user interaction that classifies particular contacts as priority contacts. Instead, the computing device can automatically discern when a particular address and/or contact has priority and/or importance over other contacts by monitoring the user's interactions, as well as lack of interactions or unsuccessful communication attempts, with the contact. Alternately or additionally, the computing device can identify various events of interest that subsequently reduce the importance of the particular address and/or contact, and automatically remove any priority assigned to the contact. This helps the user to identify when particular incoming communication events are occurring, thus improving their accessibility to the priority contact.

Having described an example of context-based modifications to an operating mode, consider now a discussion of an example device in which can be used for various implementations.

Example Device

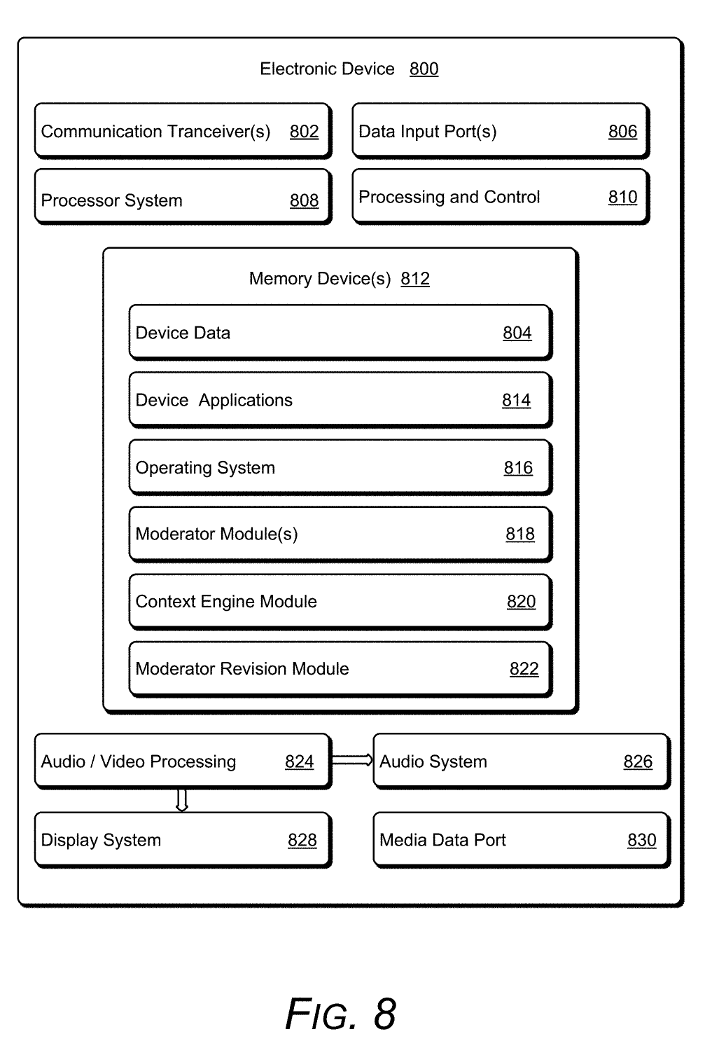

FIG. 8 illustrates various components of an example electronic device 800, such as computing device 102 of FIG. 1, that can be utilized to implement various aspects as further described herein. Electronic device 800 can be, or include, many different types of devices capable of realizing context-based action recommendations in accordance with one or more implementations.

Electronic device 800 includes communication transceivers 802 that enable wired or wireless communication of device data 804, such as received data and transmitted data. While referred to as a transceiver, it is to be appreciated that communication transceivers 802 can additionally include separate transmit antennas and receive antennas without departing from the scope of the claimed subject matter. Example communication transceivers include Wireless Personal Area Network (WPAN) radios compliant with various Institute of Electrical and Electronics Engineers (IEEE) 802.15 (Bluetooth™) standards, Wireless Local Area Network (WLAN) radios compliant with any of the various IEEE 802.11 (WiFi™) standards, Wireless Wide Area Network (WWAN) radios for cellular telephony (3GPP-compliant), wireless metropolitan area network radios compliant with various IEEE 802.16 (WiMAX™) standards, and wired Local Area Network (LAN) Ethernet transceivers.

Electronic device 800 may also include one or more data-input ports 806 via which any type of data, media content, and inputs can be received, such as user-selectable inputs, messages, music, television content, recorded video content, and any other type of audio, video, or image data received from any content or data source. Data-input ports 806 may include Universal Serial Bus (USB) ports, coaxial-cable ports, and other serial or parallel connectors (including internal connectors) for flash memory, Digital Versatile Discs (DVDs), Compact Disks (CDs), and the like. These data-input ports may be used to couple the electronic device to components, peripherals, or accessories such as keyboards, microphones, or cameras.

Electronic device 800 of this example includes processor system 808 (e.g., any of application processors, microprocessors, digital-signal processors, controllers, and the like) or a processor and memory system (e.g., implemented in a system-on-chip), which processes computer-executable instructions to control operation of the device. A processing system may be implemented at least partially in hardware, which can include components of an integrated circuit or on-chip system, digital-signal processor, application-specific integrated circuit, field-programmable gate array, a complex programmable logic device, and other implementations in silicon and other hardware. Alternatively, or in addition, the electronic device can be implemented with any one or combination of software, hardware, firmware, or fixed-logic circuitry that is implemented in connection with processing and control circuits, which are generally identified as processing and control 810. Although not shown, electronic device 800 can include a system bus, crossbar, interlink, or data-transfer system that couples the various components within the device. A system bus can include any one or combination of different bus structures, such as a memory bus or memory controller, data protocol/format converter, a peripheral bus, a universal serial bus, a processor bus, or local bus that utilizes any of a variety of bus architectures.

Electronic device 800 also includes one or more memory devices 812 that enable data storage, examples of which include random access memory (RAM), non-volatile memory (e.g., read-only memory (ROM), flash memory, EPROM, EEPROM, etc.), and a disk storage device. Memory devices 812 are implemented at least in part as a physical device that stores information (e.g., digital or analog values) in storage media, which does not include propagating signals or waveforms. The storage media may be implemented as any suitable types of media such as electronic, magnetic, optic, mechanical, quantum, atomic, and so on. Memory devices 812 provide data storage mechanisms to store the device data 804, other types of information or data, and various device applications 814 (e.g., software applications). For example, operating system 816 can be maintained as software instructions within memory devices 812 and executed by processor system 808.

In some aspects, memory devices 812 includes moderator modules 818, context engine module 820, and moderator revision module 822. While these modules are illustrated and described as residing within memory devices 812, other implementations of these modules can alternately or additionally include software, firmware, hardware, or any combination thereof.

Moderator modules 818 provide moderated operating modes to the user that enable a user to modify how electronic device 800 processes various events of interest. For example, a user can manually enable a moderator module to suppress audible and/or visual notifications associated with various events of interest. Alternately or additionally, the user can enable a moderator module to provide audible control of electronic device 800. In some implementations, a moderator module can be automatically enabled by electronic device 800 based on context information, as further described herein.

Context engine module 820 tracks information about a user that is subsequently used to generate context information. This can include name information, location information, contact information, biological information, previous communications, likes, dislikes, patterns of past communications, preferred applications, preferred websites, and so forth. In some implementations, context engine module 820 tracks raw data. Alternately or additionally, context engine module 820 generates context information from the raw data, such as through statistical analysis, data mining techniques, etc.

Moderator revision module 822 determines when to automatically revise a moderator module, such as one or more of moderator modules 818. In some implementations, moderator revision module 822 makes this determination based upon context information generated by context engine module 820. Subsequently, moderator revision module 822 alters a moderator module and/or determines when to remove the alteration as further described herein.

Electronic device 800 also includes audio and video processing system 824 that processes audio data and passes through the audio and video data to audio system 826. Audio system 826 and display system 828 may include any modules that process, display, or otherwise render audio, video, display, or image data. Display data and audio signals can be communicated to an audio component and to a display component via a radio-frequency link, S-video link, HDMI, composite-video link, component-video link, digital video interface, analog-audio connection, or other similar communication link, such as media-data port 830. In some implementations, audio system 826 and display system 828 are external components to electronic device 800. Alternatively, or additionally, audio system 826 and/or display system 828 can be an integrated component of the example electronic device 800, such as part of an integrated speaker and/or an integrated display and touch interface.

In view of the many possible aspects to which the principles of the present discussion may be applied, it should be recognized that the implementations described herein with respect to the drawing figures are meant to be illustrative only and should not be taken as limiting the scope of the claims. Therefore, the techniques as described herein contemplate all such implementations as may come within the scope of the following claims and equivalents thereof.

We claim:

1. A computer-implemented method comprising:
collecting, at a computing device, data associated with user interactions with the computing device to generate context information;
identifying, using the computing device, an event of interest;
identifying, using the computing device, one or more characteristics associated with the event of interest;
analyzing, using the computing device, the context information based on the one or more characteristics;
determining, based on the analysis and using the computing device, to alter a moderated operating mode associated with the computing device that changes how the computing device processes data relative to a default mode; and
altering, using the computing device, the moderated operating mode based on the determination to modify how the moderated operating mode processes incoming communications.

2. The computer-implemented method of claim 1, wherein the moderated operating mode comprises a notification suppression operating mode.

3. The computer-implemented method of claim 1 further comprising:
receiving a second event of interest; and
in response to receiving the second event of interest, removing the alteration to the moderated operating mode.

4. The computer-implemented method of claim 1, wherein said altering the moderated operating mode further comprises:
automatically classifying contact information used to establish communication with a destination as a priority contact effective to alter how the moderated operating mode processes communications associated with the contact information.

5. The computer-implemented method of claim 1, wherein said determining to alter the moderated operating mode further comprises determining to enable an audio control operating mode.

6. The computer-implemented method of claim 1, wherein said identifying the event of interest further comprises:
identifying a termination of an unsuccessful communication attempt with a particular contact; and
determining there have been a predetermined number of unsuccessful communication attempts with the particular contact.

7. The computer-implemented method of claim 6, wherein said receiving the second event of interest further comprises identifying a successful communication exchange associated with the particular contact.

8. The computer-implemented method of claim 1, wherein said collecting data associated with the user interactions further comprises collecting data associated with communication events.

9. A computing device comprising:
one or more processors; and
one or more computer-readable storage memories comprising processor-executable instructions which, responsive to execution by the one or more processors, enable the computing device to perform operations comprising:
collecting data associated with communication events associated with the computing device to generate context information;
identifying an unsuccessful communication attempt with a contact address;
analyzing the context information using the contact address to determine a number of unsuccessful communication attempts associated with the contact address;
determining, based on the analysis and using the computing device, to alter a moderated operating mode to alter how the moderated operating mode processes future incoming communications associated with the contact address; and
altering, using the computing device, the moderated operating mode to modify how the moderated operating mode processes the future incoming communications associated with the contact address by automatically classifying the contact address as a priority contact.

10. The computing-device of claim 9, wherein:
said analyzing the context information further comprises comparing the number of unsuccessful communication attempts to a predetermined threshold, and
said determining to alter the moderated operating mode further comprises determining the number of unsuccessful communication attempt meets or exceeds the predetermined threshold.

11. The computing-device of claim 9, wherein the contact address is not stored in an address book of the computing device.

12. The computing-device of claim 9, said operations further comprising:
removing the alteration to the moderated operating mode after a predetermined time period.

13. The computing-device of claim 12, wherein the predetermined time period comprises time period bound by an incoming communication associated with the contact address.

14. The computing-device of claim 9, wherein said analyzing the context information to determine the number of unsuccessful attempts further comprises analyzing multiple communication modes associated with the contact address.

15. The computing-device of claim 9, said operations further comprising:
receiving an incoming voice communication associated with the contact address;
determining a successful communication exchange associated with the contact address has been established; and
responsive to determining the successful communication exchange has been established, removing the alteration to the moderated operating mode by removing the priority contact classification of the contact address.

16. The computing-device of claim 9, wherein said altering the moderated operating mode further comprises enabling an audio control operating mode for the future incoming communications associated with the contact address.

17. A mobile phone comprising:
one or more processors; and
one or more computer-readable storage memories comprising processor-executable instructions which, responsive to execution by the one or more processors, enable the mobile phone to perform operations comprising:
identifying a unsuccessful communication attempt with a contact address that is not stored in an address book associated with the mobile phone;
determining based, at least in part, on said identifying the unsuccessful communication attempt, to alter a moderated operating mode to alter how the moderated operating mode processes future incoming communications associated with the contact address;
automatically altering the moderated operating mode to modify how the moderated operating mode processes the future incoming communications;
receiving an incoming communication associated with the contact address and determining the incoming communication establishes a successful communication exchange between the mobile phone and the contact address; and
removing the alteration to the moderated operating mode based on the successful communication exchange.

18. The mobile phone of claim 17, where altering the moderated operating mode further comprises altering a notification suppression operating mode to enable audible notifications for incoming communications associated with the contact address.

19. The mobile phone of claim 17, wherein altering the moderated operating mode further comprises altering an audio control operating mode to enable audio control for incoming communications associated with the contact address.

20. The mobile phone of claim 17, wherein said identifying the unsuccessful communication attempt comprises identifying an unsuccessful communication exchange associated with an outgoing voice communication to the contact address, and
wherein said determining the incoming communication establishes the successful communication exchange further comprises determining an incoming voice communication from the contact address is answered by the mobile phone.
